(19) United States
(12) Patent Application Publication
(10) Pub. No.: US 2011/0149252 A1
(43) Pub. Date: Jun. 23, 2011

(54) Electrohydrodynamic Air Mover Performance

(76) Inventors: Matthew Keith Schwiebert, San Jose, CA (US); Nels Jewell-Larsen, Campbell, CA (US); Hongyu Ran, Mountain View, CA (US); Kenneth A. Honer, Santa Clara, CA (US); Piyush Savalia, San Jose, CA (US); Yan Zhang, San Jose, CA (US); Ron Goldman, Oakland, CA (US)

(21) Appl. No.: 12/643,649

(22) Filed: Dec. 21, 2009

(51) Int. Cl. H01T 23/00; G03B 21/16

(52) U.S. Cl. 353/52; 361/231

(57) ABSTRACT

Structures for reducing the effect of charged surfaces near the electrodes on the performance efficiency of an electrohydrodynamic (EHD) device are disclosed. The potential levels on surfaces of an electronic device near the EHD electrodes are varied with respect to a function of the combination of distance from the emitter and the distance from the collector. The potential levels may be constant, may vary in discrete steps, may be continuously variable along the length between the EHD electrodes and beyond the electrodes, and may vary with respect to time.

### TECHNICAL FIELD

This application relates generally to air mover devices having no mechanical moving parts and more specifically to electrohydrodynamic air movers.

### BACKGROUND

A need exists to provide air flow over operating systems, such as electronic devices and mechanically operated devices, to help cool the systems. Cooling helps prevent device overheating in order to obtain improved long term reliability. It is known to provide cooling air flow with the use of mechanical devices such as an electric fan, however mechanical devices may have poor operating lifetimes, acoustics and other design parameters. The use of a non mechanical air mover device may result in lower vibrations, lower electronic device temperatures, and less noise generation. This may reduce overall lifetime costs, and may be expected to improved electronic device sales and profits.

The detailed description refers to the accompanying drawings that show, by way of illustration, specific aspects and embodiments in which the present disclosed teaching may be practiced. These embodiments are described in sufficient detail to enable those skilled in the art to practice aspects of the present invention. Other arrangements and embodiments may also be utilized, and structural, logical, and electrical changes may be made without departing from the scope of the disclosed embodiments. The various embodiments are not necessarily mutually exclusive, as some embodiments can be combined with one or more other embodiments to form new embodiments.

### BRIEF DESCRIPTION OF THE DRAWINGS

FIG. 1 depicts an electrohydrodynamic air mover, according to various disclosed embodiments;

FIG. 2 illustrates an improved electrohydrodynamic air flow arrangement, according to various embodiments;

FIG. 3 illustrates a different improved electrohydrodynamic air flow arrangement, according to various embodiments;

FIG. 4 illustrates another improved electrohydrodynamic air flow arrangement, according to various disclosed embodiments;

FIG. 5 illustrates an additional improved electrohydrodynamic air flow arrangement, according to various embodiments;

FIG. 6 illustrates a side view and a top view of an embodiment;

FIG. 7 illustrates a side view and a top view of another embodiment;

FIG. 8 illustrates a side view and a top view of a different embodiment;

FIG. 9 illustrates a side view and a top view of another different embodiment;

FIG. 10 illustrates a side view and a top view of yet another embodiment; and

FIG. 11 depicts a diagram of energy levels experienced by ions as found in various discussed embodiments.

### DETAILED DESCRIPTION

The use of non-mechanical air cooling systems may improve long term reliability of electronic systems by reducing mechanical part failures. Mechanical parts, such as spinning fans, have mean times to failure that may be several orders of magnitude lower than electronic components. One non-mechanical method of creating air movement may include the use of electrohydrodynamic devices (EHD), which utilize voltage potential differences between an emitter, which may be known as a corona electrode, and a collector electrode. The creation and acceleration of ions between the emitter and collector electrodes may cause the non ionized air molecules to also move in the same direction. However, the efficiency of air movement performance of an EHD air mover in an electronic device may depend in part upon the charge state or total electric potential of the portions of the electronic device in the immediate vicinity of both the emitter and collector electrodes. The walls and parts of the electronic system may have a charge or potential that affects the ions flight direction.

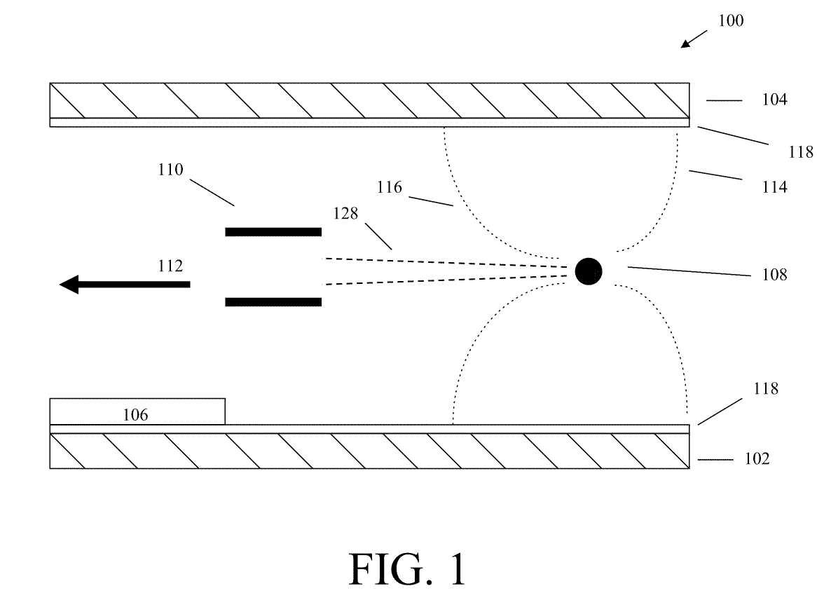

FIG. 1 depicts an electrohydrodynamic air mover 100 without direct control of the potential of the surrounding portions of the electronic system. The electronic system may have an interior portion with a lower wall portion 102, which may represent a printed circuit board (PCB) having conductive traces and attachments for electronic devices such as resistors, capacitors, inductors, transistors and integrated circuits. Alternatively the wall 102 may be a structural element, a power plane, or a heat spreader, or any of many other portions of an electronic system. The nature of the lower wall 102 is not restricted by the present disclosure and the invention may be used on any sort of adjacent surface. The electronic system may have an upper wall portion 104 that may be similar to the lower wall portion 102, and there may be additional front, back, right and left walls as well, which are not shown here for clarity and simplicity.

The walls 102 and 104 may form a straight channel as shown in FIG. 1, but the invention is not so limited, and many different internal shapes may beneficially use the presently described air mover arrangement. In particular, cavities with shapes having substantial curves and corner turning sections may use the described arrangement. The walls 102 and 104 may be formed of conductive materials, such as metals, filled plastics, certain types of ceramics such as cermets, and doped semiconductive materials, or the walls may be formed of insulative materials, such as plastics, metal oxides, metal nitrides and ceramics. The walls may support passive or active electronic devices 106 which produce heat, for example an integrated circuit (IC). The heat source 106 is shown as being to the left of the air mover components, but the invention is not so limited and the heat source may be located more remotely or between electrodes of the invention. For the case of cooling ICs, the fields 114 and 116 that may exist in the area of the electrodes may cause electrical issues. Alternatively, the air mover may also be used to cool relatively small mechanical devices that generate heat and benefit from cooling, such as micromechanical pumps, motors and sensors, or small electric motors.

An emitter electrode 108 may have an applied electrical potential to cause some of the air molecules in the region adjacent to the emitter to either gain or lose one or more electrons, and become ions having an electrical charge. The ions will move in an electrical field towards the potential most different from its own potential. The emitter and collector electrodes may each have either positive or negative potentials applied. In the case of emitter 108 having a positive potential, one or more electrons may be removed from a molecule in the surrounding air, creating a positive ion. The positive ion will move away from the positive potential on the emitter in this illustrative example and towards objects and electrodes having lower potential voltage values, which may include a collector 110. The collector 110 is shown as being formed of two parallel plates, but the invention is not so limited and the collector may take any desirable form. The collector may be a heat sink of an IC or some other heat source 106, and may have thin parallel plates for heat exchange with the moving air. Alternatively, the two shown parallel plates may be simple electrodes electrically connected together and to a desired electrical potential, such as ground. The collector may be in any physical form and have another function beyond being the collector electrode of an EHD air mover.

If the walls 102 and 104 are formed of an insulator material, they may develop a static electrical charge, which may have a lower potential value than the emitter 108 potential, in which case the ion will be attracted to the wall. Those ions striking the walls reduce the percentage of ions moving in the desired direction towards the collector 110, and may thus reduce the overall efficiency of the EHD air mover 100. Alternatively, the insulative wall may have a higher applied potential than the emitter 108, in which case the positive ion will be repelled from the wall. In either case the desired result of a direct air flow 112 from the emitter 108 to the collector 110 may be disrupted and the efficiency of the EHD system may be reduced. In an embodiment the heat source 106 may be an IC with a heat spreader or a heat pipe thermally connected to a heat dissipation device such as a heat sink having fins. The collector 110 may be formed by connecting a desired potential source to a heat sink in this embodiment.

If the walls 102 and 104 are formed of a conductive material, they may have an intentional or unintentional charge applied, for example a capacitive device, a signal conductor, or a shorted structural element. Electric field lines 114, on what may be referred to as the up wind side to the right of the emitter 108, may be attracted to the upper wall 104, or to the lower wall 102, while some of the electric field lines 116, on the down wind side of emitter 108, may be deflected towards the upper or lower wall and away from the most efficient air path 128. What ever the level or the polarity of the potential on the walls, it may still result in a reduction of air flow efficiency from the emitter 108 to the collector 110.

Whether the walls 102 and 104 are formed of an insulator material or a conductive material, it is possible to provide an anti-static layer 118, having a resistance to electrical current flow sufficient to reduce the undesired wall potential level. In an embodiment, the anti-static layer has a thickness and a material selected to provide a layer sheet resistance of 10¹⁰ to 10¹²Ω/□ (which may be read as Ohms per square). Typical insulators such as plastics may have higher resistance, typical conductive surfaces such as thin copper layers may have a sheet resistance of lower than 10⁻¹Ω/□, and static dissipative and EMI/RFI shielding layers may be above the metal sheet resistance values. The anti-static layers 118 may be connected to a desired potential voltage level, such as ground potential. With such an arrangement the buildup of unwanted potentials on the walls may be reduced and the efficiency of ion flow may be maintained.

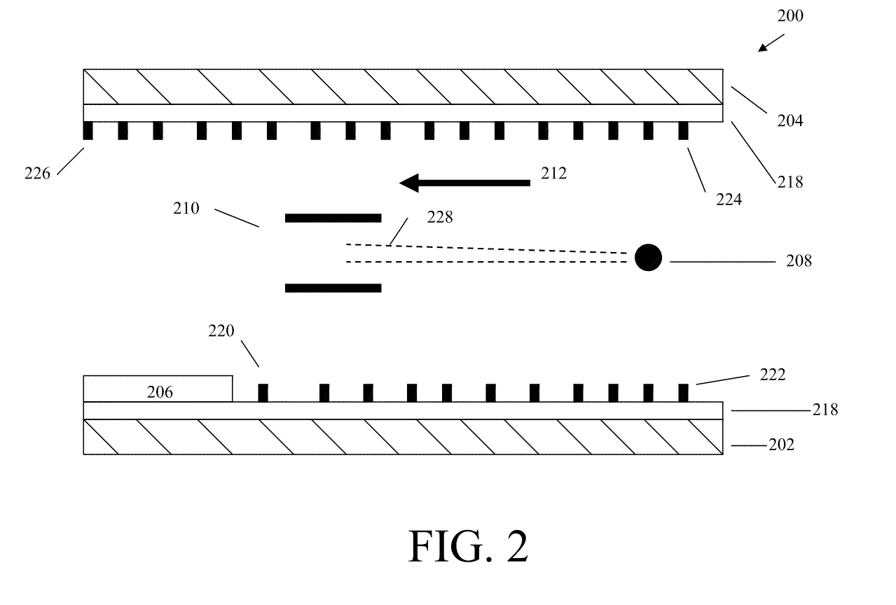

FIG. 2 illustrates an improved electrodynamic air flow arrangement 200, with two walls 202 and 204 of the electronic system shown. It should be noted that the described arrangement may include many other walls, which are not shown in the figure for clarity and simplicity. It should also be noted that the air flow 212 may not be a straight line flow as shown, but rather may be a convoluted air flow to meet the electronic system design goals. There may be a heat generating device 206, for example an IC, and an emitter electrode 208 for ionizing air molecules. The emitter has an applied charge creating a potential level to repel the generated ions, which desirably flow towards the collector 210, along the desired efficient air flow path 212. The emitter 208 and the collector 210 are should in this illustrative example as being equally distant from the walls 202 and 204, but the invention is not so limited, and the location of the electrodes may vary according to design need.

It should be noted that the field lines 228 are shown as being totally concentrated between the emitter 208 and the collector 210, but the invention is not so limited and includes the more probable cases where the number or strength of the field lines 114 and 116 of FIG. 1 are reduced, but not eliminated. The walls 202 and 204 may be covered with an anti-static layer 218 if they are formed of an insulator, or may be covered with a layer of a combination of high strength insulator and an anti-static layer if formed of an electrical conductor. In an embodiment, the layer 218 may be resistive and include a conductive layer, which may include graphite, which also may improve the thermal conduction of the heat generated by the device 206 to a heat spreader included in wall 202.

There may be a plurality of discrete electrodes formed on the surface of the walls, with each individual electrode connected to a selected potential level. The electrodes are represented by electrode 220 located on wall 202 down wind of the collector 210, electrode 222 located up wind of the emitter 208, electrode 224 located on wall 204 up wind of the emitter 208, and electrode 226 located down wind of the collector 210. The figure shows that no electrodes are located at the portion of wall 202 occupied by heat generator 206, but the invention is not so limited. In an illustrative embodiment the emitter 208 has a positive potential, in an embodiment 4,000 volts, the wall 202 is a metallic heat spreader, the layer 218 includes a high strength insulator, for example silicon dioxide or a chloro-fluorocarbon plastic, and the collector 210 is at ground potential.

Providing a potential at electrodes 222 and 224 that is higher than the potential at emitter 208 may greatly reduce or eliminate the field lines moving towards the right of the figure, as shown by lines 114 in FIG. 1. Reducing the field strength directed towards the right (or up wind direction) from the emitter 208 may result in an increased percentage of ions directed towards the collector 210, thus improving the efficiency of air flow 212 by concentrating the field lines 228 more directly towards the collector 210. In an embodiment the potential at electrode 224 is twice as high as the potential at the emitter, and may be higher than 8,000 volts.

The potential at the collector 210 may be at a lower level than the emitter 208, for example at ground potential, or zero volts. The collector 210 potential may alternatively be a negative value and be below ground potential. In an embodiment the potential of electrodes 220 and 226 to the left of the collector 210 may be lower than the collector potential. In an embodiment the electrodes closest to the collector may have a potential that is equal to the collector potential.

The specific selected values for each of the plurality of electrodes may be selected to provide an optimum distribution of potential values to enhance ion motion, and thus enhance the air flow. For example, if the air flow needed to make a turn to accommodate the design of the electronic system, the walls of the curved section could have a higher positive potential on the outside concave portion of the turn to push the ions away from straight line flight and towards the collector, while the opposing convex inner corner may have a lower potential value to attract the ions to curve away from the straight line flight and towards the collector.

In the case of the desired ion flight being directly towards the collector in a straight line, the potential of each electrode from 224 to 226 may beneficially include a potential at electrode 224 being above the emitter potential, with a reduction in potential at each individual one of the electrodes until reaching a potential equal to the collector potential at the electrodes closest to the collector 210. With such an arrangement the tendency of ions to expand away from each other and defocus the beam is reduced, and the number of ions moving up wind is reduced.

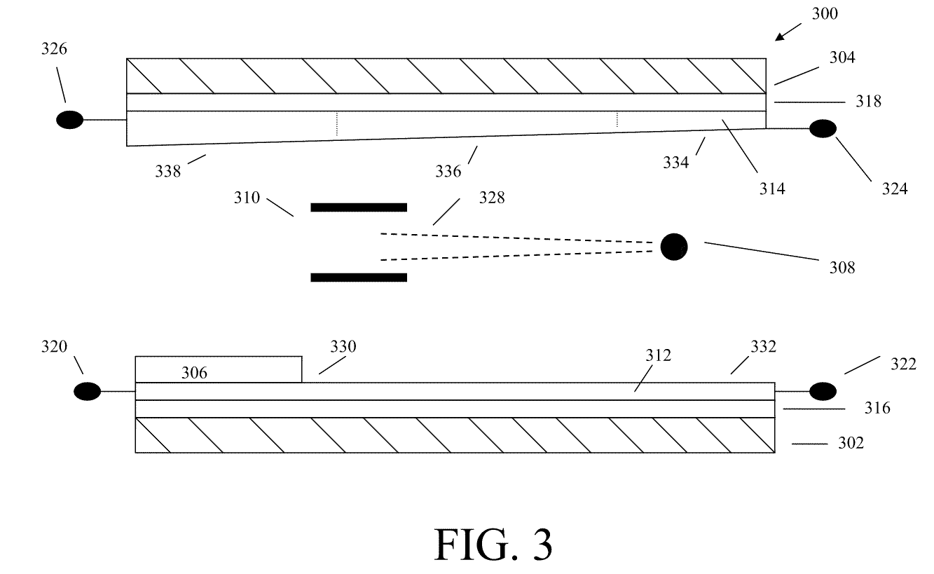

FIG. 3 illustrates another improved electrodynamic air flow arrangement 300 having walls 302 and 304, heat generator 306, emitter 308, and collector 310. The layers 316 and 318 may be strong dielectric layers, or anti-static layers, conductor layers such as metal, or a combination of layers, and substantially cover the walls. In an illustrative embodiment the continuous layers 312 and 314 disposed upon the dielectric layers 316 and 318 provide the surface potentials that control the shape of the field lines 328, and increase the efficiency of the ion movement and air movement. Such an arrangement provides a potential for continuously and smoothly variable potential levels on the walls in the region around and between the emitter and collector.

The selection of a pattern for the surface potentials may be accomplished in various ways. One illustrative embodiment may include forming layer 312 of a material such as polysilicon, which may be doped to provide different sheet resistance levels in different portions of the layer. As an example, electrical connection 322 may have an applied potential that is higher than a potential at the emitter 308, while the region 332 of layer 312 near the emitter 308 may be heavily doped to provide a low electrical resistance level. The potential of the region 332 could then slowly decline from the highest potential at 322 to a potential more closely matched to the emitter potential at a location closest to the emitter 308. The potential of layer 312 could then continue to decline slowly will moving down wind towards the collector until reaching the region marked 330 near the collector and electrical connection 320, which may be a ground potential. The region 330 of layer 312 could beneficially have a lower polysilicon doping level, resulting in higher electrical resistance, and a more rapid decline of the potential values of layer 312 at the region around the collector 310. Any pattern of doping levels and associated resistance levels may easily be formed in the polysilicon layer 312 using well known semiconductor techniques, and many other materials, doped or undoped, may be used to accomplish a similar result, specifically providing a selected variation of surface potential levels to form and guide the field lines 328 from the emitter 308 to the collector 310 efficiently.

The layer 314 on the top wall 304 may be used to describe one of many other easily understood arrangements to vary the surface potential. In an embodiment, layer 314 may be formed of undoped or uniformly doped polysilicon, or other materials having a known resistivity such as metals, conductive polymers, cermets, and semiconductors. The electrical connections 324 and 326 in this embodiment may have applied potentials equal to the emitter 308 and collector 310 respectively, or may have other potential values as desired to form and direct the field lines 328. The layer 314 may be viewed as having three regions with different layer thicknesses for simplicity of the discussion, but the invention is not so limited, and continuously variable thicknesses as shown in the figure are included. In region 334 the layer thickness is thin, resulting in a relatively high sheet resistance value and a rapid decline in potential value from the electrical connection 324 to the region closest to the emitter 308. The middle region 336 has a greater thickness and thus a slower decline in potential values for the region near the heat generator 306. The third region 338 has the thickest layer and the lowest resistance with the slowest decline in potential value to the potential of the electrical connection 326, which may be at the potential value of the collector 310. In either the variable thickness layer, or the variably doped layer case, the result is an ability to continuously or incrementally vary the potential between two or more applied potential values, and thus adjust the field shape directing the ion flow from emitter to collector.

Another embodiment does not have applied potentials or connection 324 and 326 on variable thickness resistive layer 314. In this embodiment the layer 318 is a conductive voltage plane and the electrical potential of the surface of wall 304 is formed by contact with ions generated by the emitter 308. Since the resistivity of layer 314 may be selected to be relatively high, the charge of the ions contacting the wall at region 334 will dissipate relatively rapidly through the thin layer of material 314 to the potential of the conductive voltage plane 318, while ions contacting the wall at region 336 will dissipate more slowly since the wall at 336 is thicker and thus has a higher resistance than the thinner wall at region 334. Thus the potential at region 336 will likely be higher than the potential at region 334.

Other alternative methods of controlling the potential on the surface of the walls of the electronic system may include forming the layer 312 of an electrically shocked material having a known electrostatic voltage level at which it begins to electrically leak any built up surface charges to a conductive layer 316. The material 312 may be pretreated in different regions with variable electrical shocks to provide a selected pattern of voltage levels at which leakage will begin.

Such pretreatment may include induced voltage and current levels to cause a selected level of electrical leakage in each individual region of layer 312. In an embodiment the region 332 of layer 312 may be treated lightly to provide a high potential level limit before leakage occurs, thus clamping the surface potential at a high level. The region 330 of layer 312 may be treated heavily to provide a low potential level limit to leakage, thus clamping the surface potential to a low level. In another embodiment the treatment or shocking of the layer 312 may vary continuously from a low level by the emitter 308 to a high level by the collector 310 to provide a high potential value near the emitter 308 and a low potential value near the collector. Various patterns of treatment and potential clamp levels may be easily selected depending upon the design requirements of the electronic system.

Alternatively, the pretreatment may be preformed uniformly on a layer 314 to provide a uniform level of shock and tendency to electrically leak. However in this embodiment the thinner region 334 may leak at a lower potential level since the total potential value is dropped across a much thinner layer, and thus has higher electric field strength compared to the same total potential drop across thicker region 338.

In the illustrative embodiments the electrical connections 320 and 322 having applied potentials may not be needed and the surface potential may be built up to the potential clamp level by electrostatic accumulation of positive ions formed at the emitter 308, and limited by the variable leakage. In this fashion a self induced electrostatic charge potential pattern may be created by use of controlled leakage level regions.

Other methods of controlling the build up of potential charges may include varying the sheet resistance of any of the well known anti-static materials or EMI/RFI shielding materials, and the use of electrically leaky materials having selected thicknesses to provide a selected pattern of surface potential values on the electronic system walls in the vicinity of the emitter and collector electrodes of the EHD air mover improving efficiency. Other embodiments may include varying the geometrical shape and volume of a dielectric layer on a conductive layer such as ground, and varying the cross sectional area of lines that conduct charge between the applied potentials 324 and 326, thus adjusting the resistance of the lines.

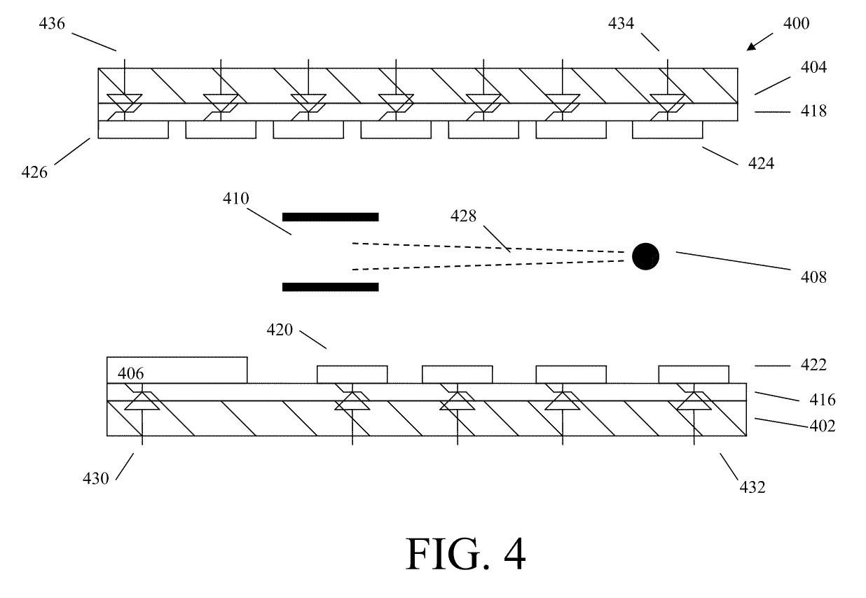

FIG. 4 illustrates an additional improved electrodynamic air flow arrangement 400 with walls 402 and 404, heat generator 406, emitter 408, collector 410, layers 416 and 418 and a plurality of electrically separated electrodes represented by electrodes 420, 422, 424 and 426. In an embodiment using at least one controllable switch connected to a desired potential value for each of the electrodes, the controllable switches represented by zener diodes 430, 432, 434 and 436. Other controllable switches such as diodes, transistors, MOSFETs, thermisters, avalanche diodes and other switches may be used in other embodiments to control the potential value on the electrodes. In an embodiment the desired potential value is the same for all the switches, and may be a ground potential.

The embodiment may operate in similar fashion to that previously disclosed and may include zener diode 432 selected to have a high breakdown voltage, which may allow a static potential on the electrode 422 to reach a high level, before the zener switches on to conduct the charge to a potential supply, for example a ground contact. In an embodiment the high breakdown level may be equal to a potential applied to emitter 408. In an embodiment the zener diode 434 may be selected for a breakdown voltage lower than zener diode 422, and zener diodes 430 and 436 may have a zero breakdown limit to provide a ground potential. The values of the zener diodes may be selected to direct the field lines 428 towards the collector and improve the EHD air mover efficiency.

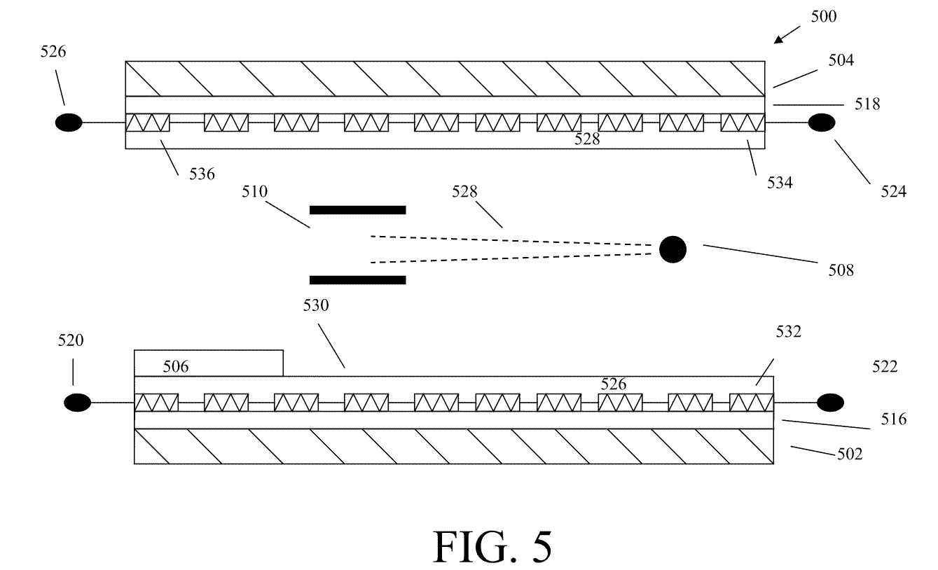

FIG. 5 illustrates an additional improved electrodynamic air flow arrangement 500 having walls 502 and 504, heat generator 506, emitter 508, collector 510 and insulator layers 516 and 518. Resistive layers 526 and 528 are formed over substantially the entirety of the insulator layer 516 and 518.

Layers 526 and 528 may have a selected resistance or a varied resistance to adjust the level of the surface potential from the applied voltage potentials of electrical connections 520, 522, 524 and 526. The resistance may have a continuous value to provide a smooth and monotonically decreasing surface potential profile from a high value at electrical connection 522 to a ground potential at electrical connection 520. Alternatively the resistance value may vary to provide a shaped potential profile to improve the direction and focus of the field lines 528, and thus the efficiency of the ion flow and the air mover. In another embodiment the surface potential may be controlled by the use of a series connected string of discrete resistors represented by resistor 530, 532, 534 and 536 as shown.

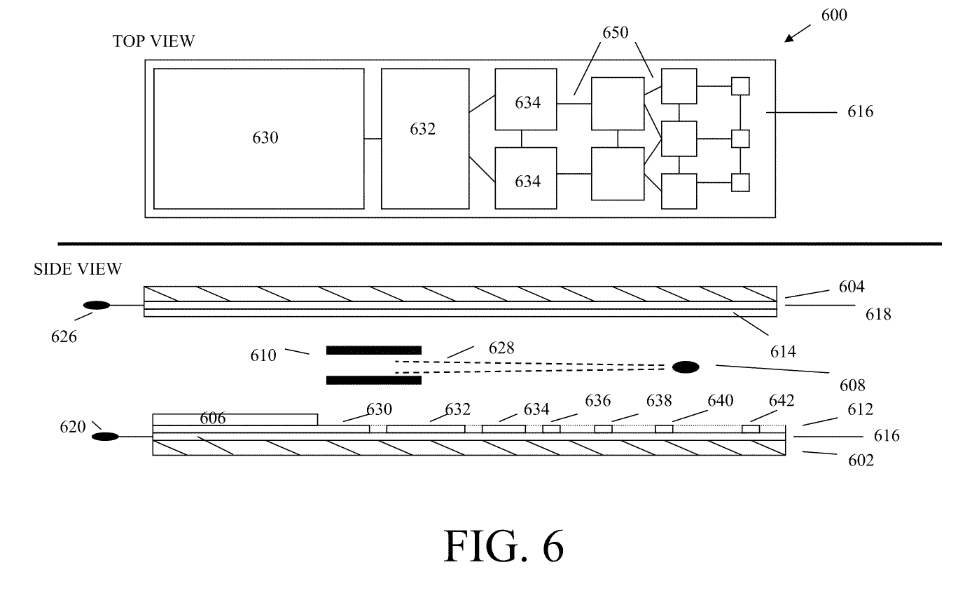

FIG. 6 depicts a top and a side view of an embodiment of an EHD air mover with walls 602 and 604 shown, although the invention is not so limited and there may be any number of nearby walls and surfaces of a system that benefits from air cooling. There is a heat source 606, which may be an IC, an emitter 608, and a collector 610, which may be connected to the heat source 606 either physically or thermally, and may be a heat sink, a heat pipe or other heat exchanger. In this embodiment the layer 616 is a partially conductive or semiconductive layer, and the electrical potential building up on the partially insulative layer 612 due to contact with ions formed at emitter 608 may vary in proportion to the total resistance to current flow from the surface to the lower voltage or ground connection related to the geometry of the various portions of layer 612. The layer 612 may be easily formed by use of what is known in the art as silk screening a selected pattern of a conductive ink material, for example a cermet material, in the embodiment a series of pads where the total surface area increases towards the collector region to provide a lower resistance to current flow and thus a lower surface potential near the collector. As shown in the figure the resistive region 630 of the layer 612 is larger than the adjacent region 632 which is larger than region 634 and so on to region 636. In addition the spacing between the resistive regions increases as well as shown with similarly sized regions 636, 638, 640 and 642 to increase resistance to current flow through the narrow connector wires 650 between the resistive regions.

The illustrative method of using silk screened patterns of resistive materials such as ink may be seen in the top view of insulative layer 616 with the individual portions of resistive layer 612 shown from the top to clarify a possible pattern. As discussed the region near the collector 610 has a larger geometric area of charge conduction to the conductive layer 616 as shown by region 630. Charge building up on region 630 from contact with ions formed at emitter 608 has a larger conduction path to a ground connection 620, 626 and thus the surface potential remains closer to ground than charges contacting the smaller regions 632 or 634, and so on, which contact ground via the network of connector wires 650. In this fashion a variable surface electrical potential may be formed on a surface of a system to control and guide the electrical field lines 628 to the collector 610, and thus create an air flow to cool heat source 606, without need for applied potentials other than a ground connection, such as 620.

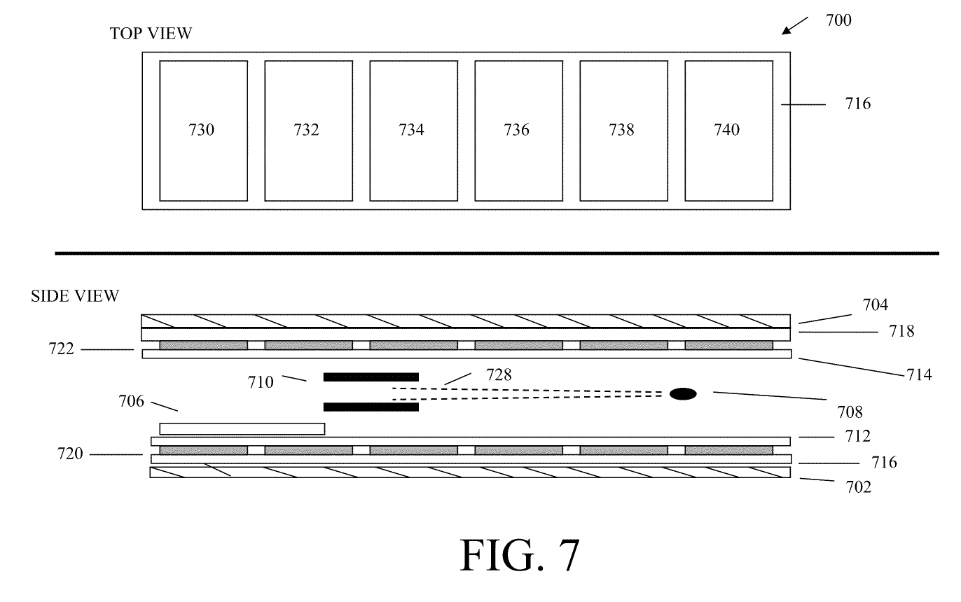

FIG. 7 depicts a top and a side view of another embodiment of an EHD air mover. The reference numbers are similar to those discussed above with reference to FIG. 6 and the differences in the embodiments will be discussed. The walls 702 and 704 may be conductive or insulative, while layers 716 and 718 are insulative. Layers 720 and 722 in this embodiment are at least somewhat conductive and may be formed of conductive inks, conductive metals and alloys, semiconductive materials. Layer 712 and 714 formed over the conductive layers are insulative. When viewed from a top view the layers 720 and 722 are formed as electrically isolated conductive plates 730, 732, 734, 736, 738 and 740. Although six conductive plates are shown the invention is not so limited and any convenient number of plates may be used. In this embodiment the plates are electrically floating, embedded under the dielectric and serve to form repelling potentials for the ions from the emitter 708. The floating plates may adjust the potential to improve the probability that the ions will move efficiently towards the collector 710. The floating plates may serve as an additional ground plane in addition to a ground plane formed using the walls 702 and 704.

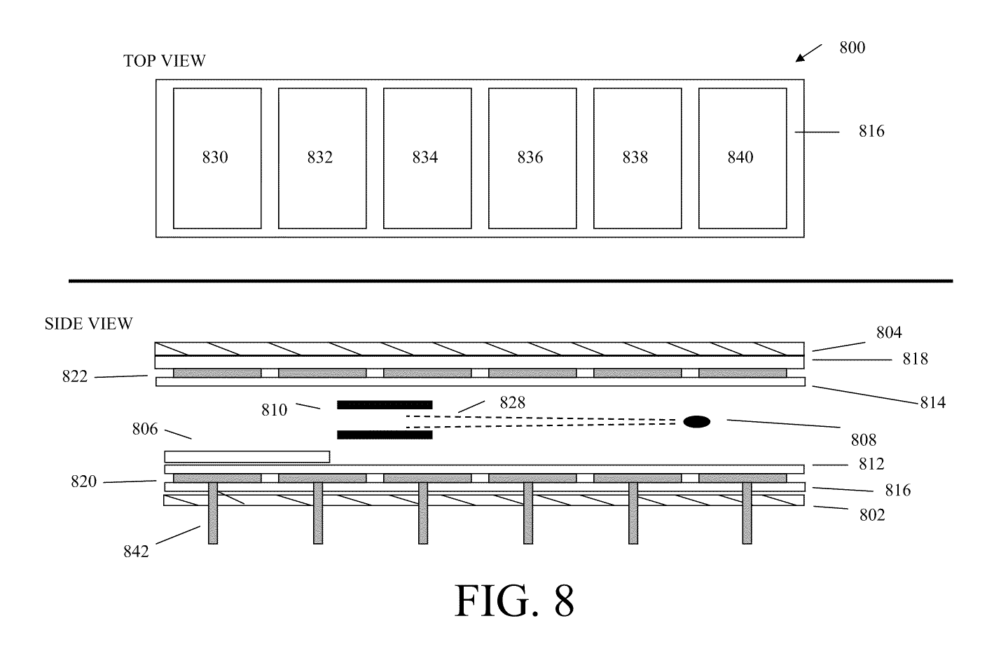

FIG. 8 depicts a top and a side view of another embodiment of an EHD air mover. The reference numbers are similar to those discussed above with reference to FIGS. 6 and 7, and again the differences with prior embodiments will be discussed. In this embodiment at least some of the conductive plates in at least one of the layers 820 and 822 have electrical connections represented by 842. Each of the conductive plates labeled 830 to 840 in the top view may be connected to a different potential level that may be actively controlled by use of potential supplies, voltage dividers or other well known voltage control methods. In this illustrative example the potential of the conductive plate nearest the emitter 808, for example 838, may be held at the same potential as the emitter, while conductive plate 840 upwind of the emitter may be held at a higher potential to repeal the ions towards the collector 810.

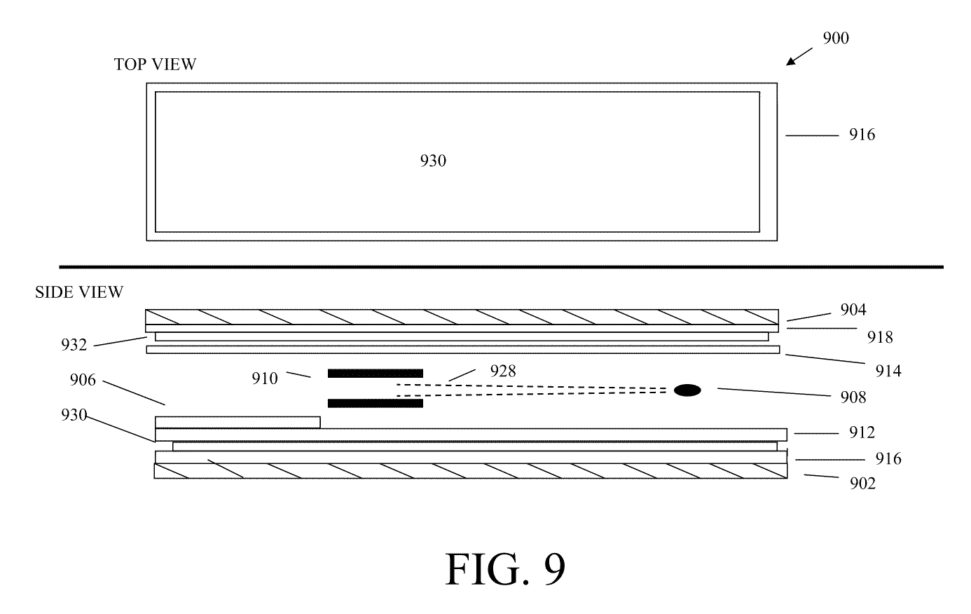

FIG. 9 depicts a top and a side view of yet another embodiment of an EHD air mover. The reference numbers are similar to those discussed above with reference to FIGS. 6, 7 and 8. In this embodiment the repelling plate formed by conductive layers 930 and 932 is a single large plate and may form a ground plane, which may be in addition to a ground plane formed by the walls 902 and 904, or may be held at a selected voltage that may be equal to the emitter potential, or may be higher than the emitter potential. The use of resistive materials in the formation of the conductive planes 930 and 932 as well as the use of a potential connection on the emitter side of the plane with a ground potential connection on the collector side may result in a controlled smoothly varying potential, as discussed in prior embodiment descriptions.

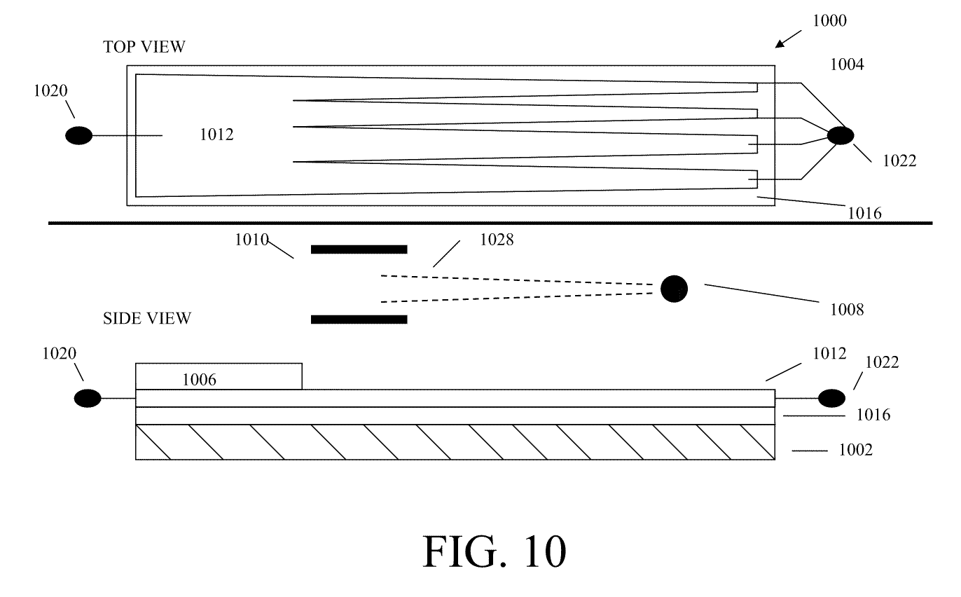

FIG. 10 illustrates another geometrical embodiment similar to the embodiment of FIG. 6, and includes a side view of a surface 1002, a heat source 1006, an emitter 1008, a collector 1010 and an insulator layer 1016. There is a conductive layer 1012 formed on top of the insulator layer 1016 and connected to external electrical potential sources at 1020 and 1022. The connection 1020 may be a ground connection while 1022 may have an applied potential greater than a potential of the emitter 1008. The top view shows that a region of layer 1012 that is near the collector 1010 has a geometry with greater cross sectional area connected to the ground potential 1020, and thus may have a surface potential close to ground. The illustration shows that the cross section area of the conductive layer 1012 decreases at a selected rate in the region near the emitter 1008, and thus may have a higher resistance to electric current and have a surface potential close to the shown connections to potential connection 1022. A method of forming the variable conductive pattern of layer 1012 may include photolithography of metal layers, or may include silk screening of conductive pastes such as conductive inks In this geometrical embodiment there are two or more external electrical potential sources, including the potential sources for the emitter 1008 and the collector 1010. While only a single wall surface 1002 is shown in the figure, the invention is not so limited and any number or shape surfaces may be used with this arrangement.

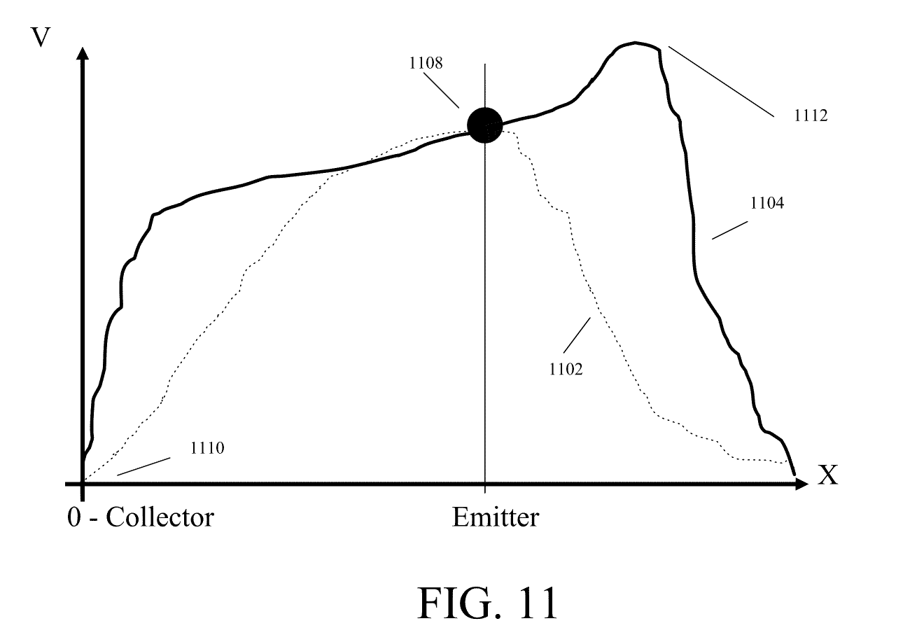

FIG. 11 illustrates a diagram of potential levels V seen by ions as found in accordance with the disclosed embodiments. In an embodiment the dashed line 1102 represents the potential environment seen by an ion in an EHD system with no active control of the wall potential and shows a high potential value at the walls near emitter 1108 and a zero potential value at the walls near the collector 810. It should be noted that the potential level found to the right of the emitter 1108 (what may be considered to be the up wind side) may be lower than the potential near the emitter 1108 on the side of the collector 1110, and thus attract positive ions created in the region around the emitter away from the collector, reducing the EHD air mover efficiency.

The solid line 1104 may represent the potential environment seen by an ion in an EHD system having controlled wall potential, and shows that at location 1112 on the up wind side of the emitter 1108 the potential is higher than the potential at the emitter and thus positive ions created at the emitter are directed towards the left (the down wind side) and towards the collector 1110, increasing the EHD system efficiency. The potential at location 1112 in certain embodiments may be higher than the emitter potential, or it may be lower than the emitter potential, depending upon the design needs of the electronic system.

With use of the above disclosed control of the electrical potential of the walls in the region of an EHD air mover, the electric field lines may be shaped and focused to obtain improved efficiency in providing air flow. In an embodiment an apparatus for moving air in an electronic system may include an emitter at a first potential level, and a collector at a second potential level located some distance from the emitter. The system may have an active component that produces heat and needs cooling on a surface, where the surface may be disposed adjacent the emitter and the collector to benefit from the cooling air flow. To improve the efficiency of the air flow, the potential or the voltage level of different portions of the surface may be incrementally or continuously varying as a function of location of each individual portion with respect to distance to the emitter and distance to the collector. These varying potential levels may trend downward from a potential level different than the emitter potential, and the wall potential may be twice as high as the emitter potential, and reach below the potential of the collector.

Those surface portions located further from the collector than from the emitter may beneficially have a potential that is higher than the collector potential, while the potential levels on the other side of the emitter from the collector may have a potential that is higher than the emitter potential. The potential level of surfaces located on the side of the collector away from the emitter may have a potential that is lower than the collector. The collector potential level may be approximately equal to ground potential while the emitter potential may be from 3500 volts to 4500 volts. The emitter may be separated from the collector by 2 mm to 4 mm, preferably from 2.5 mm to 3.0 mm, while the wall surfaces may be separated from the emitter by 0.5 to 1.5 times the emitter to collector spacing. The wall to wall spacing may be about 3 mm to 6 mm, while collector fin spacing may be from 0.5 mm to 1.5 mm, preferably 0.85 mm to 1.0 mm, with a collector fin depth in the direction of the air flow of 5 mm to 20 mm in the case of a parallel plate unidirectional heat sink. In the case where the collector is not a heat sink the plates may be smaller and have 1.0 mm to 6.0 mm spaces between the plates. The emitter may be formed of a wire having a diameter of 12.5μ to 50μ, preferably 25μ. In this fashion an essentially continuous variation in surface potential may be obtained and the flow of ions from the emitter to the collector may be directed and focused.

One arrangement for controlling the surface potentials may include an anti-static layer on the surface to conduct any built up charge to a ground supply. The anti-static layer may be carbon with a sheet resistance of 10¹⁰ to 10¹²Ω/□. Another arrangement may include a plurality of zener diodes having different breakdown levels to prevent excess build up of static charges on the surface. Another arrangement may include a dielectric layer having a controlled and variable electrical leakage to remove excess static charges. The electrical leakage may be induced by shocking a dielectric layer to create leakage sites. The electrical leakage may pass through the dielectric to a conductive line or plane.

Yet another arrangement may include a layer of material having variable resistance to determine an applied surface potential between two electrical supplies attached to the layer of material. The layer may be polycrystalline silicon layer having a variable thickness and a variable doping level. Alternatively, a series connected group of discrete resistors may be used to control the resistance and the surface potential.

One embodiment may include a plurality of individual electrodes, each connected to a selected potential level, with the potential level varying between a level that is more positive than the emitter to a level equal to the collector level, or even below the collector. Another apparatus may include a plurality of isolated electrodes each connected to a reference supply through one of a plurality of switches. The switches may include diodes and zener diodes, and each switch may turn on at a selected potential level.

An embodiment of a method to control the field environment of ions in a MHD air mover may include applying varying potential levels to selected portions of a surface disposed adjacent the emitter and collector electrodes, the potential varying as a function of distance with respect to the emitter electrode and distance to the collector electrode. The surface may include a heat source, and the heat source may be thermally connected to the collector electrode. Varying the potential level may include either a constant potential level, a continuous monotonic decreasing potential level between the emitter and collector, a plurality of discrete potential steps, a plurality of potential steps of varying magnitude and direction, continuously declining potential levels between the emitter electrode and collector electrode, continuously varying potential levels as a function of distance from the emitter electrode and collector electrode, or time variable potential levels. Applying the varying potential level may include use of variable resistance materials, active switches, electrostatic charges, variable leakage materials, or a plurality of discrete electrodes. Controlling the potential environment seen by ions may include the use of repelling conductive layers embedded in dielectric layers. They may be completely embedded and electrically floating, or may have one or more electrical connections to external potential supplies. The dielectric layers may contain portions that are electrically leaky and conduct electrical charges from the surface to the conductive layer. This may be used to form ground planes in addition to the use of the walls as ground planes, or the embedded conductive layers or electrodes may be used to apply actively controlled potentials including potentials that are the same as the emitter potential. The conductive layers may be single continuous plates, multiple plates that are either electrically isolated from each other and floating, or individually connected to selected potential levels as needed. The conductive layers may be highly conductive, partially conductive, resistive, or semiconductive, and may be formed of various materials such as metals, conductive ceramics and inks

### CONCLUSION

The use of an IC to represent a heat source is for convenience of description and ease of understanding, and the apparatus and methods described here may be used to move air in any sort of thermal module or system, including but not limited to power and heat sensitive systems such as laptop computer, battery operation electronic systems such as global positioning systems, personal digital assistants, internet capable telephone, light emitting diode systems, and small electro-mechanical devices.

The terms “potential” and “voltage” as used in the description may be considered to be synonymous in many applications, and include the concept of a difference in potential energy levels at different portions of a structure or device and include electrical potentials. The term “air flow” is understood to include linear gas flow paths, curved gas flow paths and bent gas flow paths.

The term “horizontal” as used in this application is defined as a plane parallel to the conventional plane or surface of a substrate or device, regardless of the orientation with respect to the earth. The term “vertical” refers to a direction perpendicular to the horizontal as defined above. Prepositions, such as “on”, “side” (as in “sidewall”), “higher”, “lower”, “over” and “under” are defined with respect to the conventional plane or surface of the top surface of the substrate or device, regardless of the orientation of the substrate. The detailed description is not to be taken in a limiting sense, and the scope of the present invention is defined only by the claims, along with the full scope of equivalents to which the claims are entitled.

Although specific embodiments have been specifically described herein, it will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used.

What is claimed is:

1. An apparatus for moving air in an electronic system, comprising:
an emitter having a first selected electrical potential level;
a collector having a second selected electrical potential level and located a selected distance from the emitter;
at least one surface of the electronic system surface disposed adjacent the emitter and the collector; and
individual portions of the at least one surface of the electronic system having an electrical potential level that varies as a function of location relative to the emitter and the collector.

2. The apparatus of claim 1, wherein the electrical potential levels of the individual portions vary continuously downward from a potential level different than the first selected electrical potential level

3. The apparatus of claim 1, wherein the electrical potential level of individual portions located further from the collector than from the emitter have an electrical potential that is higher than the second selected electrical potential level.

4. The apparatus of claim 1, wherein the electrical potential level of individual portions located on a side of the emitter that is further from the collector have an electrical potential that is higher than the first selected electrical potential level.

5. The apparatus of claim 1, wherein the collector is thermally coupled to a heat source disposed upon the at least one surface of the electronic system.

6. The apparatus of claim 1, wherein the electrical potential level of individual portions located on the side of the collector further from the emitter have an electrical potential that is lower than the first selected electrical potential level.

7. The apparatus of claim 1, wherein the second selected electrical potential level is selected to be approximately equal to ground potential.

8. The apparatus of claim 1, wherein the at least one surface includes a plurality of individual electrodes, each individual electrode connected to a selected one of a plurality of electrical potential levels.

9. The apparatus of claim 1, wherein the first selected electrical potential level is more positive than a reference level and the second selected electrical potential level has a value equal to the reference level.

10. The apparatus of claim 1, further including an anti-static layer disposed on the at least one surface of the electronic system.

11. The apparatus of claim 10, wherein the anti-static layer includes carbon and has a sheet resistance of about 10¹⁰ to 10¹²Ω/□.

12. The apparatus of claim 1, wherein the at least one surface includes a layer of a material having a varied resistance, the layer being connected to a first external electrical potential level in a first region near the emitter and to a second external electrical potential level in a second region near the collector.

13. The apparatus of claim 12, wherein the layer includes a polycrystalline silicon layer having at least one of a variable thickness and a variable doping level.

14. The apparatus of claim 12, wherein the layer includes a series connected plurality of resistors connected between the first external electrical potential and the second external electrical potential, each individual one of the plurality of resistors having a selected resistance value.

15. The apparatus of claim 1, wherein the at least one surface includes a layer of a material having a selected varied electrical leakage level.

16. The apparatus of claim 15, wherein the layer of a material is shocked to create a selected pattern of regions each having a selected electrical potential value resulting in electrical leakage to a conductive line.

17. The apparatus of claim 1, wherein the at least one surface includes a plurality of electrodes electrically isolated from each other, and each one of the plurality of electrodes connected to a reference supply through one of a plurality of switches.

18. The apparatus of claim 17, wherein the plurality of switches include a diode.

19. The apparatus of claim 18, wherein the diode includes a zener diode.

20. The apparatus of claim 17, wherein each one of the plurality of switches turns on at a selected electrical potential level.

21. The apparatus of claim 1, wherein the heat source includes an active component of the electronic system.

22. The apparatus of claim 12, wherein the second external electrical potential level in a second region near the collector is approximately ground potential and the first external electrical potential is left floating.

23. A method for improving efficiency in an air flow system, comprising:
applying a first selected potential level to an emitter electrode;
applying a second selected potential level to a collector electrode disposed a selected distance from the emitter electrode; and
applying a selected varying potential level to selected portions of at least one surface disposed adjacent the emitter electrode and the collector electrode, the surface including a heat source;
the potential on the at least one surface varying as a function of distance with respect to the emitter electrode and distance to the collector electrode.

24. The method of claim 23, wherein the varying potential level is selected to be between a potential level twice as high as the first selected potential and a potential level lower than the second selected potential level.

25. The method of claim 23, wherein applying a selected varying potential level includes at least one of a constant potential level, a continuous monotonic decreasing potential level between the emitter electrode and collector electrode, a plurality of discrete potential steps, a plurality of potential steps of varying magnitude and direction, continuously declining potential levels between the emitter electrode and collector electrode, continuously varying potential levels as a function of distance from the emitter electrode and collector electrode, and time variable potential levels.

26. The method of claim 23, wherein applying a selected varying potential level includes at least one step of applying a potential to a variable resistance material, applying a potential to each one of a plurality of active switches, collecting a plurality of electrostatic charges on a surface having variable dielectric breakdown values, collecting electrostatic charges on a surface having variable leakage material to an electrical potential conductor, and applying a selected potential to each of a plurality of discrete electrodes.

27. An apparatus for moving air in a thermal module, comprising:
an emitter having a first electrical potential level;
a collector having a second electrical potential level; and
a surface of the thermal module disposed adjacent the emitter and the collector including a surface electrical potential level varying as a function of location relative to the emitter and the collector.

28. The apparatus of claim 27, wherein the surface electrical potential at some location may be higher than the first electrical potential.

29. The apparatus of claim 27, wherein the collector may be a heat dissipation device.

30. The apparatus of claim 27, wherein the surface electrical potential includes at least one external electrical potential supply.

31. The apparatus of claim 27, wherein the surface electrical potential includes contact with ions generated by the emitter and varied by one of a pattern of electrical resistance, a pattern of electrical breakdown levels, a plurality of switches and a plurality of conductive materials.

32. An apparatus for cooling a portable electronic device, comprising:
an emitter having a first electrical potential level;
a collector having a second electrical potential level; and
a surface of the portable electronic device adjacent the emitter and the collector including a surface electrical potential level varying as a function of location relative to the emitter and the collector.

33. The apparatus of claim 32, wherein the surface electrical potential at some location may be higher than the first electrical potential.

34. The apparatus of claim 32, wherein the collector may be a heat dissipation surface.

35. The apparatus of claim 32, wherein the surface electrical potential includes at least one external electrical potential supply.

36. The apparatus of claim 32, wherein the surface electrical potential includes contact with ions generated by the emitter and varied by one of a pattern of electrical resistance, a pattern of electrical breakdown levels, a plurality of switches and a plurality of conductive materials.

37. An apparatus for cooling a LED light source projector, comprising:
an emitter having a first electrical potential level;
a collector having a second electrical potential level; and
a surface of the LED light source projector adjacent the emitter and the collector including a surface electrical potential level varying as a function of location relative to the emitter and the collector.

38. The apparatus of claim 37, wherein the LED light source projector comprises a portion of at least one of a television receiver, a video monitor, a flat panel display and a television camera.

39. The apparatus of claim 37, wherein the LED light source projector comprises a portion of at least one of a computer, a laptop computer, a notebook computer, a personal digital assistant, an All-In-One personal computer and a handheld computing device

40. An apparatus for moving a gas, comprising:
an emitter having an electrical contact for connecting to an electrical potential source;
a collector having an electrical contact to an electrical potential source; and
a solid surface adjacent the emitter and the collector including a controlled variable electrical potential level that varies as a function of location relative to the emitter and the collector.

41. An apparatus for moving air, comprising:
a first electrode having a first electrical potential level;
a second electrode having a second electrical potential level; and
at least one dielectric surface disposed adjacent the first and second electrodes including an at least partially conductive layer disposed below the dielectric having an electrical potential level varying as a function of location relative to the first and second electrode.

42. The apparatus of claim 41, wherein the at least partially conductive layer comprises at least one of a single continuous electrode, a plurality of electrically isolated electrodes, a metallic conductor, a semiconductor, a resistive material and a conductive paste.

43. The apparatus of claim 41, wherein the electrical potential level of the at least partially conductive layer is held at the first electrical potential level.

44. The apparatus of claim 41, further including at least one external electrical potential supply connected to at least one portion of the at least partially conductive layer disposed below the dielectric to actively control the potential level.

45. The apparatus of claim 41, wherein the at least partially conductive layer is completely embedded in the at least one dielectric surface.

46. The apparatus of claim 45, wherein the at least partially conductive layer includes at least one external electrical connection.

47. The apparatus of claim 45, wherein the at least one dielectric surface includes at least a portion including an electrically leaky material enabled to allow current flow to the at least partially conductive layer.
